(19) United States
(12) Patent Application Publication
(10) Pub. No.: US 2004/0254022 A1
(43) Pub. Date: Dec. 16, 2004

(54) Light weight low angle fixed constant velocity joint and improved packaging

(76) Inventors: Ramon Kuczera, Clarkston, MI (US); Frederick Uchman, Clarkston, MI (US)

Correspondence Address: DINNIN & DUNN, P.C., 2701 CAMBRIDGE COURT, STE. 500, AUBURN HILLS, MI, 48326, US

(21) Appl. No.: 10/840,968

(22) Filed: May 6, 2004

Related U.S. Application Data
(60) Provisional application No. 60/469,479, filed on May 9, 2003.

(51) Int. Cl. F16D 3/16

(52) U.S. Cl. 464/145

(57) ABSTRACT

An improved constant velocity joint includes an outer race and an inner race arranged within the outer race. The joint includes a cage arranged between the outer race and inner race and a rolling element arranged between the outer race and inner race. The constant velocity joint outer race has a reduced diameter and a reduced head length for reduced weight, reduce packaging and easier installation into a vehicle driveline system.

### BACKGROUND OF THE INVENTION

1. Field of the Invention

The present invention generally relates to constant velocity joints and more particularly relates to a light weight low angle fixed constant velocity joint having improved packaging.

2. Description of the Related Art

Constant velocity joints (CV joints) are common components in automotive vehicles. Typically, constant velocity joints are used where a transmission of constant velocity rotating motion is required. The common types of constant velocity joints are plunging tripod, a fixed tripod, a plunging ball joint and a fixed ball joint. These types of joints are currently used in front wheel drive vehicles, rear wheel drive vehicles and on propeller shafts found in rear wheel drive, all wheel drive, and four wheel drive vehicles. The constant velocity joints are generally grease lubricated for life and sealed by a sealing boot when used on driveshafts or half shafts. Therefore, constant velocity joints are sealed in order to retain grease inside the joint and keep contaminates, such as dirt and water out of the joint. To achieve this protection the constant velocity joint is usually enclosed at the opened end of the outer race by a sealing boot made of a rubber, thermoplastic, or silicone type material. The opposite end of the outer race generally is enclosed by a dome or cap, known as a grease cap in the case of a disk type joint. The mono block or integral stem and race design style joint is sealed by the internal geometry of the outer race. This sealing and protection of the constant velocity joint is necessary because contamination of the inner chamber of the joint generally will cause internal damage to the joint.

A constant velocity joints main function is the transmission of rotational forces and torque. In the prior art constant velocity joint assemblies, a variety of bolted joint designs are used to assemble a joint to a propshaft or halfshaft within the automotive vehicle. The torque transfer generates heat by the internal friction of the joint along with other transmission inefficiencies. Generally, as the speed and torque increase the heat generation of the constant velocity joint also increases. Many of these prior art constant velocity joints are capable of operating at specific angles which can be anywhere from a few degrees all the way up to 75 or 80 degrees. Many of these high angle constant velocity joints have a maximum angle and have to meet specific durability, strength and fatigue requirements. Some of these requirements include strength and fatigue at angle, strength and fatigue in a straight ahead condition, and quasi static strength at angle. The design of the prior art joints allow for these joints to operate at such high angles based on specific designs for the outer race, inner race, cage and rolling elements of these prior art constant velocity joints. However, many of these prior art constant velocity joints that operate at high angles on wheel ends or the like generally are very complicated to design and install. Many of these prior art joints are positively retained to the stub shafts within the wheel end environment or inboard environment of a half shaft such that once the joint is put together the joint itself cannot be disassembled unless the entire half shaft assembly is removed. Furthermore, many of these prior art constant velocity joints that operate at high angles require very heavy components and very large components which increases packaging requirements and weight for these constant velocity joints. Also the complexity of installation and design of such joints increases the cost of the constant velocity joints to the manufacturers of the automotive vehicles.

Therefore, there is a need in the art for a constant velocity joint that can operate at high angles that includes a reduced mass constant velocity joint. There also is a need in the art for a constant velocity joint that reduces the packaging space needed for the constant velocity joint in the driveline of the automotive vehicle. Furthermore, there is a need in the prior art for a reduced cost and easier to install, design and produce constant velocity joints for the automotive vehicle. There also is a need for a constant velocity joint that is capable of being disassembled without disassembling the entire driveline half shaft environment.

### SUMMARY OF THE INVENTION

One object of the present invention is to provide an improved constant velocity joint.

Another object of the present invention is to provide a constant velocity joint that can operate at high angles.

Yet a further object of the present invention is to provide a constant velocity joint that has reduced mass, reduced packaging space and reduced costs to produce and install in a vehicle driveline.

Still a further object of the present invention is to provide a constant velocity joint that has a reduced head length and a reduced outer diameter.

It is yet a further object of the present invention to use an improved cage that requires less material removal from the window area of the cage.

It is yet a further object of the present invention to provide a constant velocity joint that uses a cage with an integrated angle stopper to prevent over articulation of the joint.

It is still a further object of the present invention to provide a constant velocity joint with improved assembly that allows the improved cage to be directly inserted into the mouth of the joint without rotation by 90 degrees.

It is yet a further object of the present invention to provide a constant velocity joint that has reduced costs, it is easier to install and has reduced weight.

To achieve the foregoing objects, a constant velocity joint according to the present invention is disclosed. The constant velocity joints includes an outer race and an inner race arranged within the outer race. The constant velocity joint also includes a cage arranged between the outer race and inner race. A rolling element is arranged between the outer race and inner race and positioned by the cage therebetween. The constant velocity joint outer race has a reduced diameter and a reduced head length.

One advantage of the present invention is that it provides an improved constant velocity joint.

Another advantage of the present invention is that it provides a reduced mass, reduced packaging space requirement and reduced cost constant velocity joint for use in a vehicle.

Still a further advantage of the present invention is that the constant velocity joint has a reduced outer diameter and a reduced head length.

Still another advantage of the present invention is that the constant velocity joint is easier to install and has a lower cost than prior art joints.

Yet a further advantage of the present invention is the use of an improved cage that requires less material at the window area and reduces the thickness of the window area for easy installation into the constant velocity joint.

Still a further advantage of the present invention is the ease of disassembly of the constant velocity joint.

Still another advantage of the present invention is a cage having an integrated angle stopper to prevent over articulation of the joint.

Still a further advantage of the present invention is the use of a retaining ring in the cage as an angle stopper feature for the constant velocity joint.

Other objects, features, and advantages of the present invention will become apparent from the subsequent description and appended claims, taken in conjunction with the accompanying drawings.

### BRIEF DESCRIPTION OF THE DRAWINGS

FIG. 1 shows a plan view of a vehicle driveline.

FIG. 2 shows a constant velocity joint in partial cross section according to the present invention.

FIG. 3 shows a comparison of the constant velocity joint according to the present invention and a prior art constant velocity joint.

FIG. 4 shows a partial cross section of a constant velocity joint according to the present invention at angle.

FIG. 5 shows a prior art constant velocity joint cage and a cage for the constant velocity joint of the present invention in a side-by-side comparison.

FIG. 6 shows a constant velocity joint in partial cross section with a prior art cage prior to assembly therein.

FIG. 7 shows a constant velocity joint in partial cross section according to the present invention showing the improved cage assembly prior to assembly.

FIG. 8 shows a partial cross section of the constant velocity joint according to the present invention.

FIG. 9 shows an enlarged view of the angle stopper feature of FIG. 8.

### DESCRIPTION OF THE PREFERRED EMBODIMENT(S)

Referring to the drawings, a constant velocity joint 10, according to the present invention, is shown. It should be noted that all types of CV joints, such as plunging tripods, a fixed tripod, etc., may be used with the present invention.

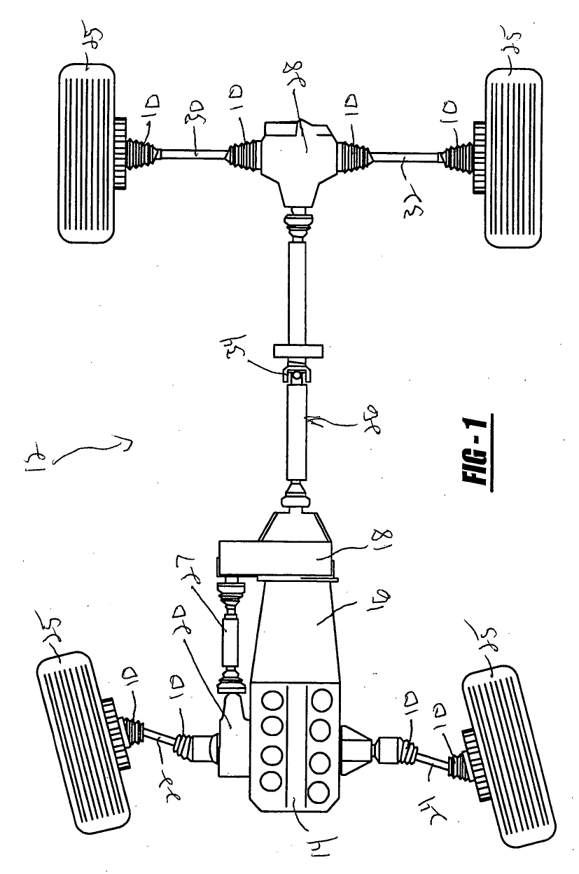

FIG. 1 shows a typical driveline 12 of an automotive vehicle. The driveline 12 of FIG. 1 represents a typical all wheel drive vehicle, however it should be noted that the constant velocity joints 10 of the current invention can also be used in rear wheel drive vehicles, front wheel drive vehicles, all wheel drive vehicles and four wheel drive vehicles. The driveline 12 includes an engine 14 that is connected to a transmission 16 and a power take off unit 18. The front differential 20 has a right hand side half shaft 22 and a left hand side half shaft 24, each of which are connected to a wheel 25 and deliver power to those wheels. On both ends of the right hand front half shaft 22 and left hand front half shaft 24 are constant velocity joints 10. A propeller shaft 27 connects the front differential 20 to the power take off unit 18. A propeller shaft 26 connects the power take off unit 18 to the rear differential 28, wherein the rear differential 28 includes a rear right hand side shaft 30 and a rear left hand side shaft 32, each of which ends with the wheel 25 on one end thereof. A constant velocity joint 10 is located on both ends of the half shafts that connect to the wheel 25 and the rear differential 28. The propeller shaft 26, as shown in FIG. 1, is a two piece propeller shaft that includes a Carden joint 34 and two high speed constant velocity joints. The constant velocity joints transmit power to the wheels 25 through the driveshaft 26 even if the wheels or the shaft have changing angles due to steering and suspension jounce and rebound. The constant velocity joints 10 may be of any of the standard types known, such as plunging tripod, cross groove joint, fixed ball joint, fixed tripod joint, or double offset joints, all of which are commonly known terms in the art for different varieties of constant velocity joints. The constant velocity joints 10 allow for transmission of constant velocities at angles which are found in everyday driving of automotive vehicles in both the half shafts and prop shafts of these vehicles.

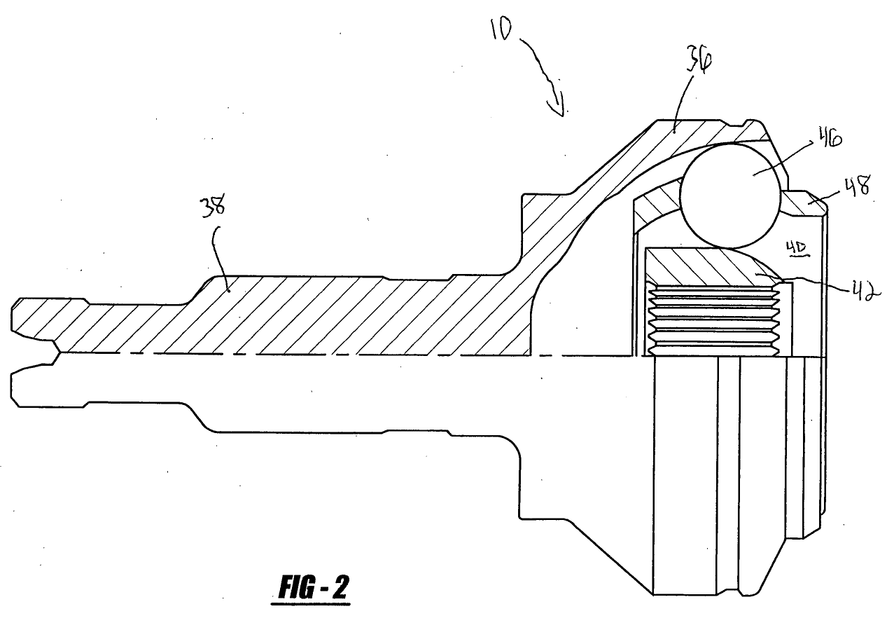

FIGS. 2 through 5, and 7 and 8 show an embodiment of the current invention. The constant velocity joint 10 is a fixed constant velocity joint which is generally used in a half shaft of a vehicle on either the wheel end or inboard transmission side of the half shaft. The constant velocity joint 10 of the present invention is typically designed to maximize the angle the joint is capable of obtaining. For example, in a front wheel drive vehicle, the fixed joint is typically the joint at the wheel 25, thus it is required that the joint have a high articulation angle to support steering of the vehicle. With this requirement the fixed type constant velocity joint is frequently over designed in many respects for use as a rear half shaft joint where the requirement for steering is either non existence or greatly reduced. Therefore, the present invention will allow for the design of a fixed constant velocity joint 10 for high angles that is capable of being used in either a front half shaft position or a rear half shaft position or maybe even both if design requirements dictate such. It should also be noted that any other type of CV joint may also be used, however, a fixed constant velocity joint 10 is the preferred joint for use in the present invention.

The constant velocity joint 10 includes an outer race 36 which has an integral shaft 38 attached to one end thereof. It should be noted that the shaft 38 may be a separate piece and connected to the outer race 36 of the constant velocity joint 10 by any known fastening mean. An inner wall of the outer race 36 generally defines a constant velocity joint chamber 40. An inner race 42 is located or arranged within the outer race 36. The inner race 42 is connected to a stub shaft 44, drive shaft, half shaft, or prop shaft of the vehicle. A plurality of rolling elements 46, balls in our specific embodiment, are arranged between an outer surface of the inner race 42 and an inner wall of the outer race 36. The balls 46 are held in position between the outer race 36 and inner race 42 surfaces by a cage 48. Each race ball 46 is located within an indentation of the outer race inner surface. The rotation of the outer race 36 will rotate the inner race 42 at the same or constant speed thus allowing for constant velocity to flow through the joint 10 between the half shaft and the wheel or transmission at an angle up to a predetermined fixed angle. The constant velocity joint 10 will allow the angle to change because the balls 46 will rotate and compensate for any difference in angle between the shafts by moving within the outer race and inner race indentations. It should be noted that the stub shaft or half shaft 44 is secured to the inner race 42 via any known fastener and is generally positively retained to the inner race 42 after assembly of the constant velocity joint 10.

A boot cover (not shown) is connected to an end of the outer race 36. A boot member (not shown) is arranged between the boot cover or outer race and the stub shaft 44. The boot member may be made of a urethane or any type of hard or soft plastic, rubber, fabric, etc.

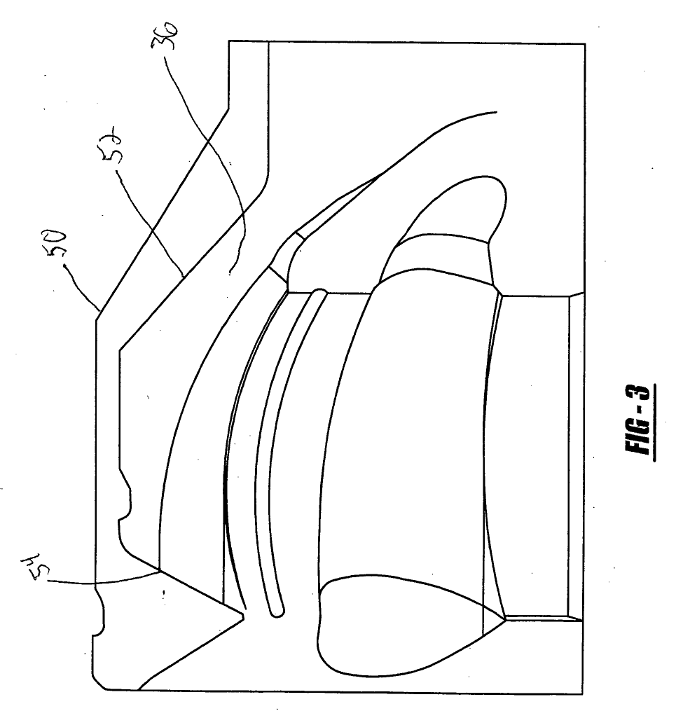

The outer race 36 of the constant velocity joint 10 will have its outer diameter optimized or maximized to allow for the constant velocity joint 10 to have a sufficient quasi static strength at angle. The outer diameter cannot be designed too small because when the joint 10 is at maximum steering angle and subjected to high torque the bell of the outer race 36 of the joint may rupture or become damaged. Therefore, as shown in FIG. 3, in a comparison with a prior art joint 50, the outer diameter 52 of the constant velocity joint 10 has been reduced with respect to prior art constant velocity joints that are used on half shafts. The outer race 36 also must have a specific head length 54 for the constant velocity joint 10 based on the articulation angle required such that there is sufficient length in the ball tracks to support the balls 46 and the necessary clearance required to rotate the cage 48 to assemble the joint 10 and some minimum section thickness required to carry the torque through the constant velocity joint 10. The reducing of the outer diameter 52 and head length 54 will reduce costs of the constant velocity joint 10 and reduce the packaging space required for the component in the vehicle. The reduction in costs can be had by the following and other requirements, such as less material, reduced grinding time, reduced forging costs, etc. The high angle constant velocity joint 10 for the present invention is one that may be used in a rear half shaft or front half shaft and operate up to a maximum angle of 25 degrees. Hence, the reduction of head length 54 and the outer diameter 52 will allow for compensation for lower stresses and quasi static strength at angle. It should be noted that the constant velocity joint 10 can be designed and optimized to operate at any specific maximum angle between 10 degrees to 75 degrees. The embodiment shown in the figures is for a joint that operates at a maximum angle of 25 degrees and preferably in a rear half shaft of an automotive vehicle. However, the same design requirements for the outer race 36 may be used for a high angle front half shaft joint such as one that operates at 50 degrees. Therefore, this design will allow for multiple joints to be designed for each vehicle thus reducing the costs of individual joints for each individual vehicle by specifically designing and then installing joints for each half shaft on either a wheel end or inboard transmission side.

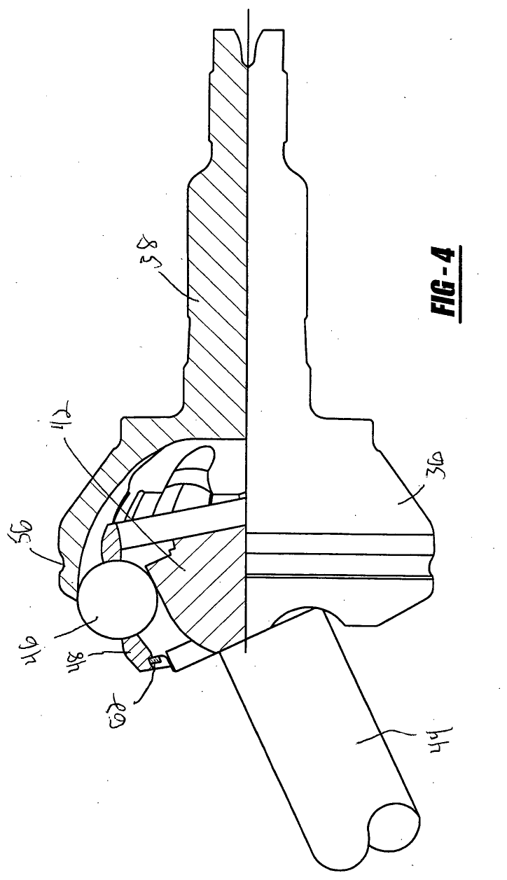

The constant velocity joint 10 of the present invention has a maximum articulation angle of 25 degrees and may be used as a constant velocity joint on the inboard or transmission side of the front half shafts and on both the transmission and wheel end of the rear half shafts of the vehicle driveline. With the reduced diameter and head length of the outer race 36 the constant velocity joint 10 will reduce the weight of the constant velocity joint 10 by approximately 30% over prior art joints. As shown in FIG. 2 and FIG. 4, the constant velocity joints also have a boot groove further inboard on the outer surface of the outer race 36 of the constant velocity joint 10 closer to the pivot point of the constant velocity joint 10. Moving the boot groove 56 to such a position will improve the boots durability thus increasing the overall durability of the constant velocity joint 10 over prior art joints by allowing for a higher sealability of the boot and thus constant velocity joint during operation.

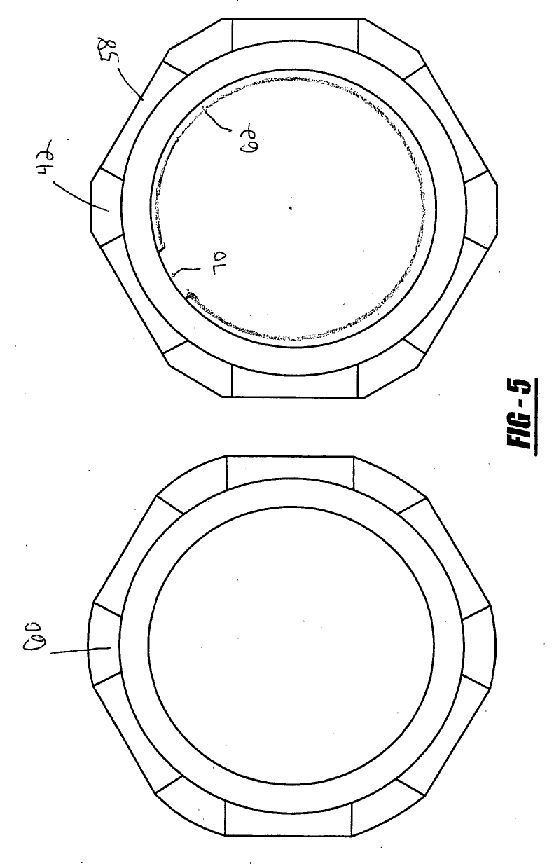

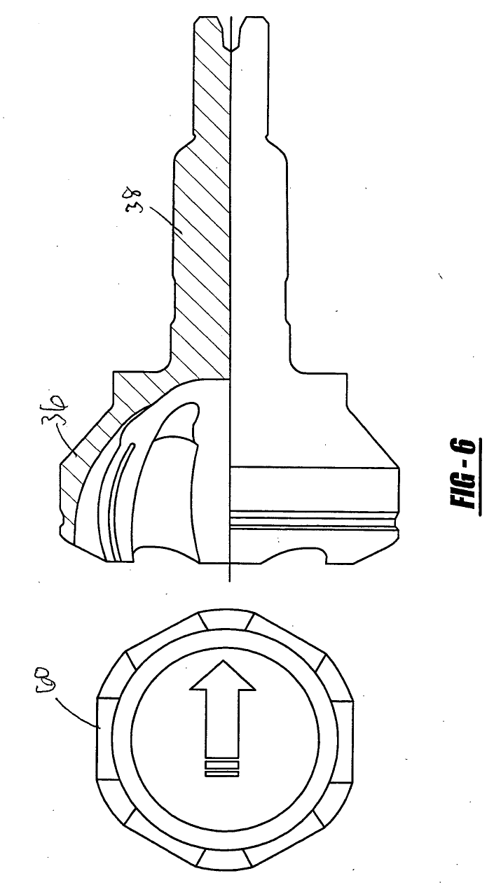

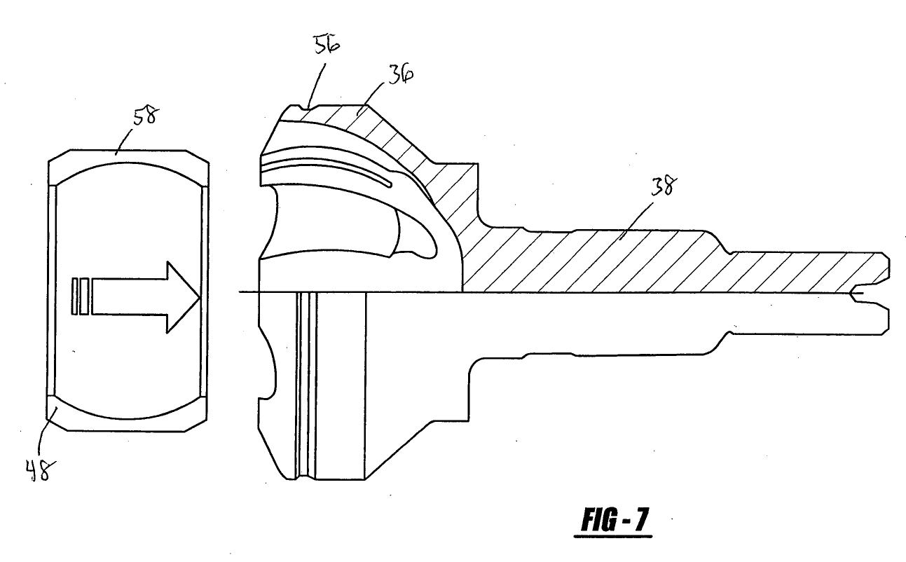

FIG. 5 shows a comparison of the improved cage used in the present invention on the right side and a prior art cage used in a prior art constant velocity joint such as that shown in FIG. 6. The improved cage 48 for the present constant velocity joint 10 requires less material removal from the window area 58. This allows for a reduced thickness of the window area 58 of the constant velocity joint cage 48. With the articulation requirement dramatically reduced for the present invention the cage 48 support necessary for the rolling element 46 is reduced thus allowing for a thinner cage 48 or a cage 48 that reduces the thickness of the window area 58 and thus the amount of material to be removed to create the plurality of windows in the surface of the cage 48. Generally, the window punch thickness area has been reduced by approximately 22% over that of prior art cages. However, it should be noted that more or less material may be added thus either reducing the window thickness or increasing the window thickness by whatever the design requirements of the constant velocity joint 10 require. The reduced thickness of the constant velocity joint cage 48 will allow for improved and easier assembly of the cage 48 into the constant velocity joint 10. Generally, traditional cages 60 as shown in FIG. 6, had to be inserted into the mouth of the fixed constant velocity joint outer race 36 at a 90 degree orientation to an installed position and then rotated into position. The improved cage 48 having the reduced thickness may be directly inserted into the mouth of the joint 10 without rotation by 90 degrees as shown in FIG. 7. This will reduce the complexity of the installation of the cage 48 into the constant velocity joint 10 and also allow for the disassembly of the constant velocity joint 10 once it is positively retained to the shaft 44 of the vehicle driveline system. The flat surfaces of the window area 58 of the improved cage 48 allows for the ease of assembly and disassembly of the joint 10. It should be noted that the reduced thickness window area 58 of the improved cage 48 also will allow for the windows in the cage 48 to be punched out versus that of the thicker cages of the prior art which have the windows machined into the cage surface.

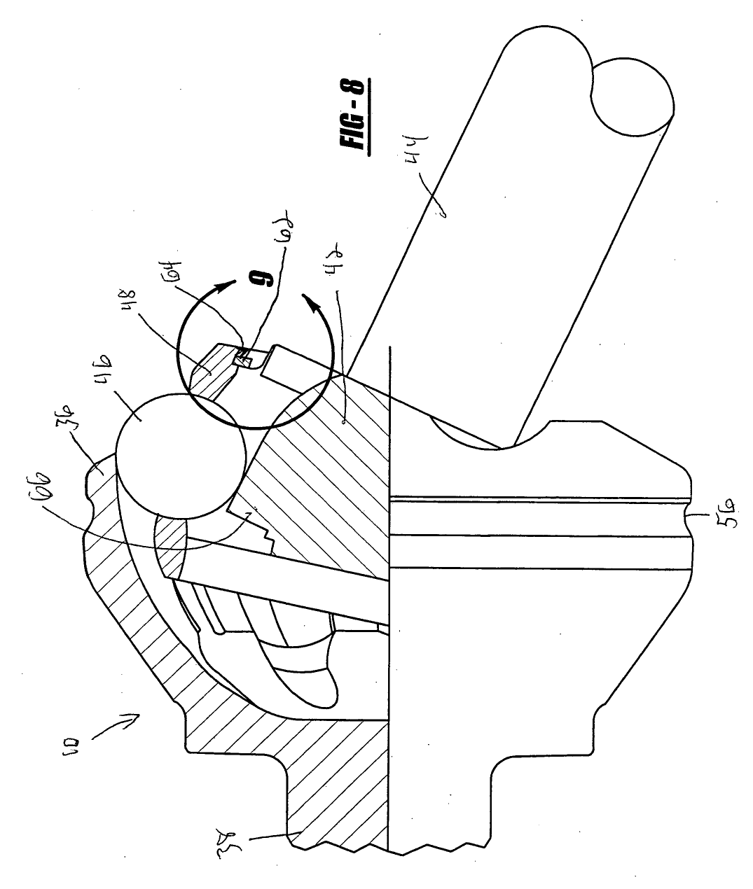

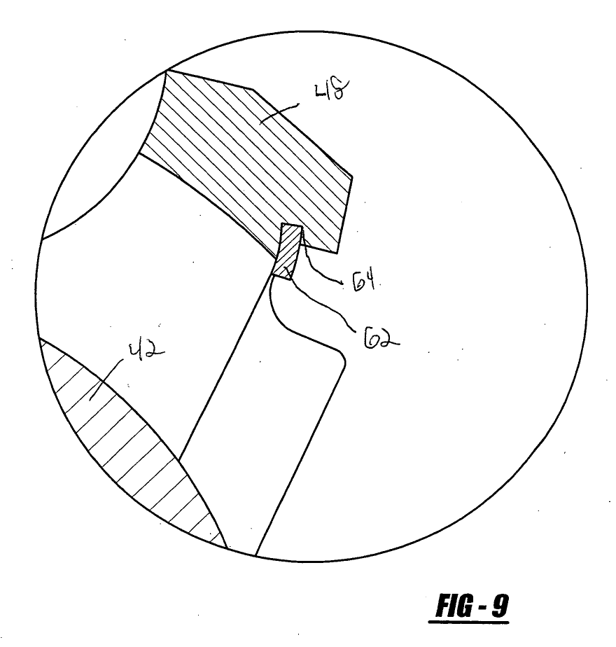

The cage 48 of the present invention as shown in FIGS. 8 and 9 also includes an integrated angle stopper 62 to prevent over articulation of the constant velocity joint 10. In many prior art designs the end of the shaft when assembled to the joint would protect the joint from over articulation by contacting the bell of the outer race 47 maximum angle. In the constant velocity joint 10 of the present invention the outer race 36 has been lightened and shortened to such a degree that it no longer prevents over articulation. Over articulation can result in the balls 46 not being held in the joint 10, thus possibly allowing disassembly during handling of the joint 10. The angle stopper feature 62 as shown in FIGS. 8 and 9 generally is a retaining ring 62 arranged in a circumferential groove 64 on an inner surface of the cage 48. The retaining ring 62 will extend a predetermined radial distance from the inner surface of the cage 48 of the constant velocity joint 10. The retaining ring 62 may be arranged around the entire 360 degree circumference of the inner surface of the cage 48 or it may have a predetermined sized gap within the ring 62. The predetermined sized gap in one embodiment will be slightly larger or larger than the width of one lobe 66 of the inner race 42. This will allow at least one lobe 66 of the inner race 42 to pass through the gap of the retaining ring 62 thus allowing for the joint to be articulated to a larger angle in that one position. This additional articulation angle could be useful for vehicle installation. In operation, the constant velocity joint 10 only needs to be rotated until either the specific lobe is aligned with the gap and then the inner race 42 can be over articulated beyond the angle stopper feature 62 thus allowing for increased articulation. It should be noted that in one contemplated embodiment only one specific lobe will have a width corresponding to the gap 70 thus requiring that specific lobe be aligned with the gap to allow for disassembly. However, in other contemplated embodiments any of the lobes of the inner race 42 may also align with the gap to allow for easy disassembly. The design requirements of such disassembly feature one variable depending on the environment the constant velocity joint 10 will be used in.

The angle stopper feature 62, in the preferred embodiment, as shown is a retaining ring 62 on an inside surface of the cage 48. However, other angle stopper features have been contemplated. Such features may be but are not limited to a localized deformation of the cage 48 after the constant velocity joint 10 is assembled. Further, an angle stopper feature may be a localized deformation of the outer race 36 after the constant velocity joint 10 of the present invention is assembled. Other angle stopper features may also be used according to the present invention. It should be noted that in one contemplated embodiment if the joint requires service the retainer ring 62 can be removed allowing joint disassembly, even in positive retention joints.

The constant velocity joint 10 with a predetermined distance between the outer race 36 of the fixed joint 10 and the center line of pivot has been reduced as shown above due to the improved cage assembly requirement for the constant velocity joint 10 using the improved cage 48. In operation and during assembly the constant velocity joint inner race 42 will have the stub shaft or half shaft 44 positively fixed to an orifice in the inner race 42 via any known fastening means. Then as shown in FIG. 7 the improved cage 48 will be assembled into the outer race 36 of the constant velocity joint 10 without the need for a 90 degree rotation after assembly therein. Next the inner race 42 will be placed within the inner bore of the improved cage 48 and then the rolling elements 46 will be aligned within the specific ball tracks of the outer race 36 and inner race 42 until all of the balls 46 of the constant velocity joint 10 have been inserted. It should be noted that any number of balls 46 may be used such as a six ball joint, eight ball joint, ten ball joint, twelve ball joint, or any other known number of ball joints for the present invention may be used. After the joint 10 is assembled by having the cage 48, inner race 42 and shaft 44 inserted and arranged within the outer race 36, the retaining ring 62 of the constant velocity joint cage 48 will be inserted. This will allow for the joint 10 to prevent over articulation during handling and operation of the joint 10. This will allow for a positively retained shaft 44 within the constant velocity joint 10 as required by many automotive vehicle manufactures. However, the use of the retaining ring 62 with a predetermined gap will also allow for easy disassembly of the constant velocity joint 10 without having to remove the entire half shaft assembly from the automotive vehicle. It should be noted that all of the parts described in the present invention are generally made of a steel material, however any other metal, hard ceramic, plastic, composite, or the like may also be used for any of these parts in the constant velocity joint of the present invention.

The present invention has been described in an illustrative manner, it is to be understood that the terminology which has been used is intended to be in the nature of words of description rather than of limitations.

Many modifications and variations of the present invention are possible in light of the above teachings. Therefore, within the scope of the appended claims, the present invention may be practiced otherwise than as specifically described.

What is claimed is:

1. A constant velocity joint, said joint including:
an outer race;
an inner race arranged within said outer race;
a cage arranged between said outer race and said inner race;
a rolling element arranged between said outer race and said inner race; and
said outer race having a reduced diameter and a reduced head length.

2. The constant velocity joint of claim 1 wherein adjusting said diameter and said head length of said outer race will allow the joint to operate at a plurality of predetermined angles.

3. The constant velocity joint of claim 2 wherein one of said predetermined angles is approximately 25 degrees for a front inboard joint or a rear joint.

4. The constant velocity joint of claim 1 wherein said outer race having a thirty percent reduction in mass.

5. The constant velocity joint of claim 1 wherein said cage having a reduced thickness at a window area.

6. The constant velocity joint of claim 1 wherein said cage is inserted into the joint without rotating 90 degrees.

7. The constant velocity joint of claim 1 wherein said cage having a retaining ring on an inside surface of said cage.

8. The constant velocity joint of claim 7 wherein said retaining ring having a predetermined sized gap therein.

9. The constant velocity joint of claim 8 wherein said gap approximately equals a width of one lobe of said inner race.

10. The constant velocity joint of claim 9 wherein the joint having positive retention of a shaft secured to said inner race and an ability to disassemble the joint.

11. The constant velocity joint of claim 1 further including an angle stopper.

12. The constant velocity joint of claim 11 wherein said angle stopper is a deformation of said cage after assembly and a deformation of said outer race after assembly.

13. The constant velocity joint of claim 12 wherein a distance between one of said races of the joint and a centerline of pivot of the joint being reduced to a predetermined distance.

14. A high angle constant velocity joint for use in a driveline system, said joint including:
an outer race;
an inner race arranged within said outer race;
a cage having a reduced thickness window area arranged between said inner race and said outer race;
a rolling element arranged between said outer race and said inner race; and
a shaft engaged with said inner race.

15. The joint of claim 14 wherein said cage having a retaining ring on an inside surface of said cage.

16. The joint of claim 15 wherein said retaining ring having a gap therein.

17. The joint of claim 16 wherein said gap at least equals a width of a lobe of said inner race.

18. The joint of claim 14 wherein said shaft having positive retention within said inner race and the joint is capable of disassembly.

19. The joint of claim 14 wherein said window area thickness is reduced by approximately 15 to 30 percent.

20. The joint of claim 14 wherein said outer race having a reduced head length and a reduced diameter.

21. The joint of claim 20 wherein said outer race having an approximate 30 percent reduction in weight.

22. The joint of claim 14 wherein said cage is assembled into the joint without rotating 90 degrees.
